(19) United States
(12) Patent Application Publication
(10) Pub. No.: US 2018/0350261 A1
(43) Pub. Date: Dec. 6, 2018

(54) BEHAVIOR ENCOURAGEMENT SYSTEM AND METHODS

(71) Applicant: Jonathan A. Petrone, South Hempstead, NY (US)

(72) Inventor: Jonathan A. Petrone, South Hempstead, NY (US)

(21) Appl. No.: 16/001,211

(22) Filed: Jun. 6, 2018

Related U.S. Application Data
(60) Provisional application No. 62/515,903, filed on Jun. 6, 2017.

(51) Int. Cl. G09B 19/00

(52) U.S. Cl. CPC G09B 19/00; H04L 67/10

(57) ABSTRACT

A system and methods for behavior encouragement includes a software application configured to provide audio information, a toy device including a figurine, a speaker, a wireless receiver configured to receive the audio information provided by the software application, and hardware electronics configured to process the audio information for output to the speaker, and a cloud server configured to communicate with the software application, the cloud server configured to receive text information from the software application, convert the text information into the audio information, and provide the audio information to the software application.

### CROSS-REFERENCE TO RELATED APPLICATION

This application claims priority to U.S. Provisional Application No. 61/515,903, filed on Jun. 6, 2017, which is hereby incorporated by reference herein in its entirety as if set forth fully herein.

### FIELD OF THE TECHNOLOGY

The present device and methods relate in general to the field of educational toys, and in particular to, education toys for encouraging behavior.

### BACKGROUND

Children have been playing with toys for a long time, particularly with dolls, figurines, puppets, or the like, and with variations such as interactive dolls and remotely controlled toys. A toy or other plaything may stimulate a child's brain, especially his or her imagination. Further, an interactive toy may enhance the child's playing experience and may influence their behavior. Most of these toys have pre-set parameters and limited configuration, and are usually hard to modify.

Therefore, there is continuing interest in developing more flexibility into interactive toys to help with behavioral issues.

### SUMMARY

Existing challenges associated with the foregoing, as well as other challenges, are overcome by methods for pairing and managing a figurine or interactive toy with a smart device to help a child with behavioral issues, and also by systems, apparatuses, and computer-readable media that operate in accordance with the methods. More specifically, the present disclosure relates to an audio-enabled figurine or toy which can influence behavior. For example, the figurine or toy may encourage good behavior in an individual by audibly reminding the individual to perform certain tasks every day, and the figurine or toy may be configured to support the good behavior via a behavior reinforcement system such as a reward system. In this way, the disclosed technology integrates smart devices (i.e. cellphones, pcs, or tablets) and toys in such a way that parents can have more control over content and other configurations associated with an interactive toy.

According to aspects of the present disclosure, a system for behavior encouragement includes a software application configured to provide audio information, a toy device including a wireless receiver configured to receive the audio information provided by the software application, and a cloud server configured to communicate with the software application, where the cloud server is configured to receive text information from the software application, convert the text information into the audio information, and provide the audio information to the software application. The toy device further includes a figurine, a speaker, and hardware electronics configured to process the audio information for output to the speaker.

In various embodiments, the toy device includes a dispenser configured to dispense a reward. In various embodiments, the software application is further configured to track the reward on a calendar. In various embodiments, the toy device includes a housing enclosing the hardware electronics, the dispenser, and the speaker. In various embodiments, the housing includes an opening operably coupled to the dispenser and sized for the dispenser to dispense the reward through the opening.

According to aspects of the present disclosure, a method for behavior encouragement includes receiving text information at a software application, communicating the text information from the software application to a cloud server configured to convert the text information into audio information, receiving at the software application the audio information from the cloud server, accessing a wireless connection to a toy device having a speaker, and communicating, over the wireless connection, the audio information to the toy device for output by the speaker.

In various embodiments, the method for behavior encouragement includes locally storing the text information and the audio information in a device where the software application is located. In various embodiments, the method for behavior encouragement includes locally storing a plurality of text information and a plurality of corresponding audio information received from the cloud server, where the plurality of text information includes the text information and the plurality of corresponding audio information includes the audio information.

In various embodiments, the method for behavior encouragement includes receiving at the software application a selection of one of the plurality of text information, accessing by the software application one of the plurality of audio information corresponding to the selected text information, and communicating, over the wireless connection, the one of the plurality of audio information to the toy device for output by the speaker.

In various embodiments, the method for behavior encouragement includes tracking, by the software application, rewards on a calendar, where the toy device further includes a reward dispenser. In various embodiments, the method for behavior encouragement includes communicating, over the wireless connection, an instruction to the toy device to dispense a reward, and tracking, at the software application, in the calendar that a reward has been dispensed.

Further details and aspects of exemplary embodiments of the present disclosure are described in more detail below with reference to the appended figures.

### BRIEF DESCRIPTION OF THE DRAWINGS

The accompanying drawings, which are incorporated in and constitute a part of this specification, illustrate embodiments of the present disclosure and, together with a general description of the present disclosure given above, and the detailed description of the embodiments given below, serve to explain the principles of the present disclosure.

FIG. 1 depicts an exemplary embodiment for a device for behavior encouragement, in accordance with the present disclosure;

FIG. 2A depicts an exemplary embodiment of a housing of the device of FIG. 1, in accordance with the present disclosure;

FIG. 2B depicts an exemplary embodiment of the bottom side of the housing of FIG. 2, in accordance with the present disclosure;

FIG. 3 depicts an exemplary system for behavior encouragement, in accordance with the present disclosure;

FIG. 4 depicts an exemplary screen of a software application, in accordance with the present disclosure;

FIG. 5 depicts an exemplary screen of a software application for entering text, in accordance with the present disclosure;

FIG. 6 depicts an exemplary screen of a software application for saving entered text, in accordance with the present disclosure;

FIG. 7 depicts an exemplary screen of a software application for managing saved text, in accordance with the present disclosure;

FIG. 8 depicts an exemplary screen of a software application for instructing an reward to be dispensed, in accordance with the present disclosure;

FIG. 9 depicts an exemplary screen of a software application for tracking reward progress, in accordance with the present disclosure; and

FIG. 10 is a flow diagram of a process, in accordance with the present disclosure.

### DETAILED DESCRIPTION

Detailed embodiments of the present system and method are disclosed herein. It is to be understood, however, that the disclosed embodiments are merely exemplary of the system and methods as a whole, which may be embodied in various and alternative forms. The figures are not necessarily to scale, and some figures may be configured to show the details of a particular component. Therefore, specific structural and functional details disclosed herein are not to be interpreted as limiting, but merely as a representative basis for the claims and for teaching one skilled in the art to practice the present invention.

Various embodiments of the presently disclosed toy system and methods of using the same will be described in detail with reference to the drawings wherein like references numerals identify similar or identical elements.

The present disclosure relates to an audio-enabled figurine or toy which can influence behavior. For example, the figurine or toy may encourage good behavior in an individual by audibly reminding the individual to brush their teeth every day, and the figurine or toy may be configured to support the good behavior via a behavior reinforcement system such as a reward system. As used herein, the term “figurine” refers to and includes a toy statue, effigy, doll, stuffed animal, or the like.

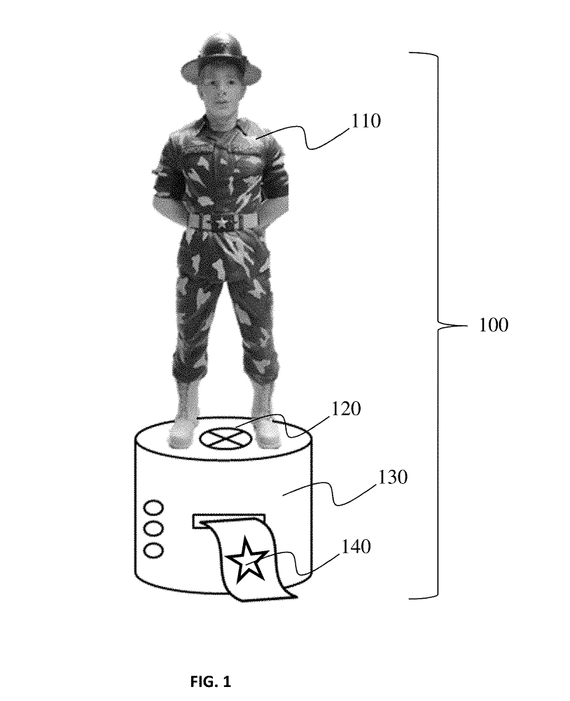

Referring to FIG. 1, an embodiment of a toy device 100 in accordance with the present disclosure is shown. The toy device 100 includes a figurine 110, a speaker 120, a housing 130 that includes a wireless receiver, and a reward item 140. In the illustrated embodiment, the figurine 110 is configured as a toy soldier, or more specifically, configured to resemble an officer or a sergeant. It is understood that the figurine can be configured to have any other appearance, such as a super hero, stuffed animals, famous media personalities, or even simple objects which may be appeal to very young children, such as a square, triangle, or the like. The figurine 110 finds particular use in the encouragement of a selected behavior and the enforcement thereof. In particular, the figurine 100 can have selected characteristic that demand a user's attention and respect. For example, the appeal of figurine 110 may be tailored in view of a selected user's preference. As shown in the exemplary embodiment of FIG. 1, the figurine 110 can be configured as a U.S. Army Sargent, which may represent or communicate the feeling of respect, discipline, courage, or the like.

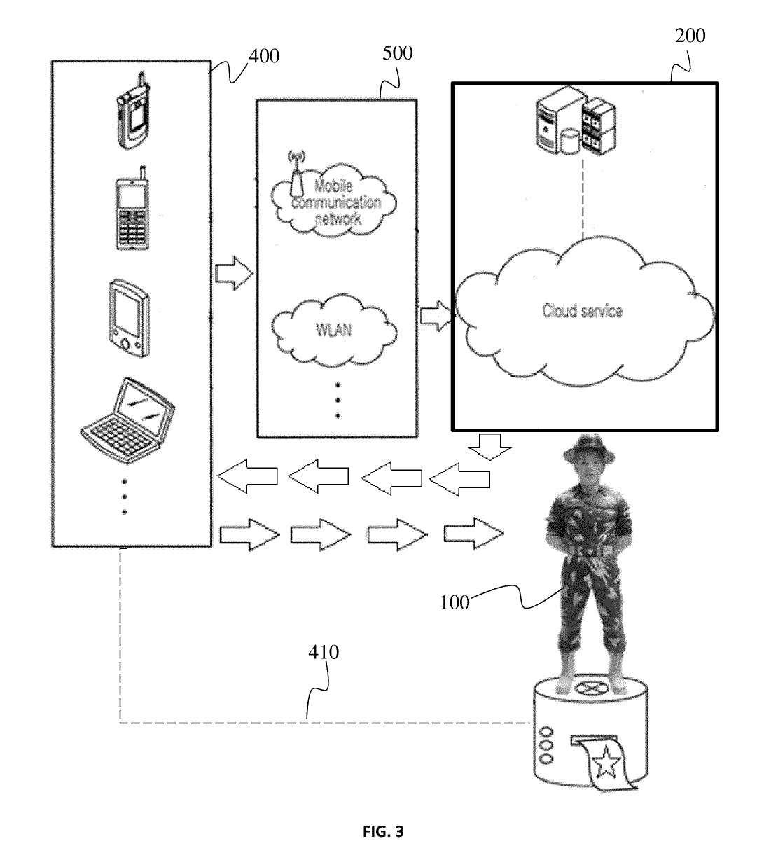

In embodiments, the speaker 120 may be embedded into the housing 130 below the figurine 110, or in various embodiments can be embedded into the figurine 110. For example, in FIG. 1, speaker 120 is disposed below figurine 110 and within the housing 130. The housing 130 encloses the speaker 120, the wireless receiver (not shown), hardware electronics (not shown), and a reward dispenser (not shown). The hardware electronics can operate to process audio information for output by the speaker, which will be described in more detail in connection with FIG. 3. In various embodiments, the wireless receiver, the hardware electronics, and/or the reward dispenser can be enclosed within the figurine 110 rather than in the housing 130.

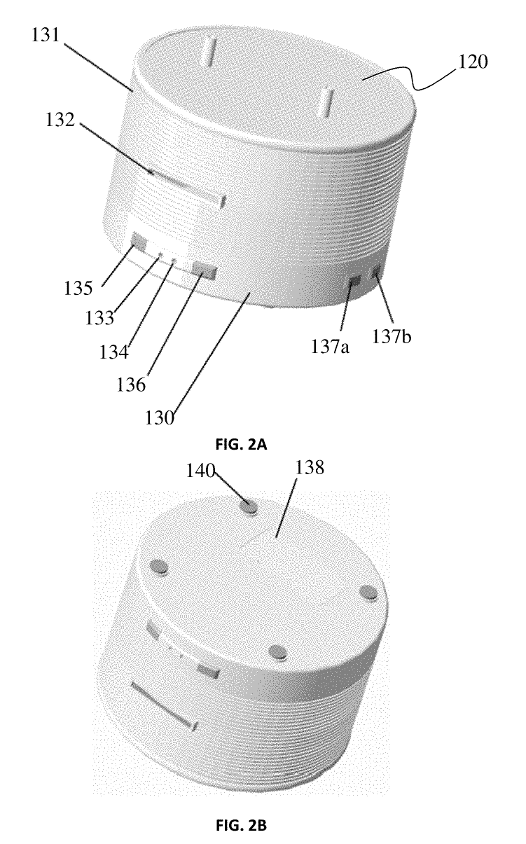

Referring now to FIG. 2A, an embodiment of the housing 130 is shown. The housing 130 includes a body 131 and an opening 132. The opening 132 can be operably coupled to the reward dispenser (not shown) which can be configured as a label dispensing machine. Further, the toy device 100 may include light indicators configure to give a visual indication of the system status at a glance. For example, in various embodiments, the housing 130 may include a wireless connection indicator 133 and a power light indicator 134. The wireless connector indicator 133 may be configured to light up or switch colors when a connection between the toy device 100 and an external device 400 is established. The power indicator 134 may be configured to light up when the toy device 100 is in use or turned on. Further, the housing 130 may further include knobs or command buttons such as a reward dispensing button 135, a power switch 136, and volume buttons 137a and 137b, which may be configured to control the output level of speaker 120. The reward dispenser button 135 may be operably coupled to the reward dispenser (not shown) and may be configured to control the speed at which the reward dispenser (not shown) dispenses a roll including a reward such as a sticker 140. The power switch 136 may be operably coupled to the power light 134. It is understood that the above-noted elements can be operably coupled to the hardware electronics which implement the described functionality.

With reference to FIG. 2B, the housing 130 may further include a series of supports or non-slip components 140. For example, when placing case 130 onto a surface, non-slip components 140 may reduce sliding of the housing 130 or may reduce the probability of damaging the surface in contact with the housing 130. The non-slip components 140 can be located on a bottom surface 138 of the housing 130 and configured to provide support and stability to the housing 130 when placed onto a surface.

With reference to FIGS. 2A and 2B, the speaker 120 is placed along a top surface of the housing 130, but in various embodiments, can be placed along any other surface of the housing 130.

Turning now to FIG. 3, there is shown a system for behavior encouragement in accordance with aspects of the present disclosure. As mentioned above, the toy device 100 can be operably coupled to an external device 400 via a wireless connection 410. For example, the wireless connection 410 may utilize one or more of Bluetooth, UWB, ZigBee, and/or Wi-Fi, among other protocols. More specifically, the wireless receiver (not shown) in housing 130 can establish the wireless connection to the external device 400. The external device 400 can be a cellular phone, a tablet, a PDA, a laptop computer, a smart watch, or another type of computing device. It is understood that the external device 400 is equipped with a wireless transceiver or other suitable device that may enable wireless connection to the toy device 100.

In embodiments, the external device 400 is configured to wirelessly connect with and communicate with a cloud server 200 via a network 500. The network can include various types of communications technologies, such as WLAN (namely Wi-Fi), cellular communications, wired communications, or other suitable network communications. Cloud server 200 may be configured to communicate with a software application on the external device 400, in such a way that the cloud server 200 may be configured to receive text information from the software application. The server 200 can convert the received text information into audio information and then provide the audio information back to the software application 300. For example, the audio information can be a synthesized audio clip that reads the text information provided by the software application. As a more specific example, if the text information provided by the software application is “Sergeant Simon says, remember to brush your teeth,” the cloud server 200 can generate an audio clip that includes a voice speaking these words, and can transmit this audio clip back to the software application of the external device 400. In various embodiments, the voice that speaks the words can be customized to match the figurine of the toy device 100. In various embodiments, the voice need not match the figurine of the toy device 100. Ultimately, the audio information is relayed to the toy device 100 to be played via the speaker 120 of the toy device 100.

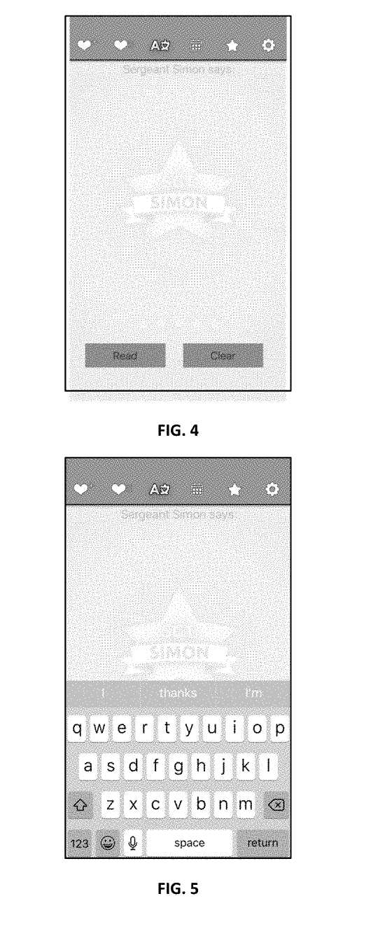

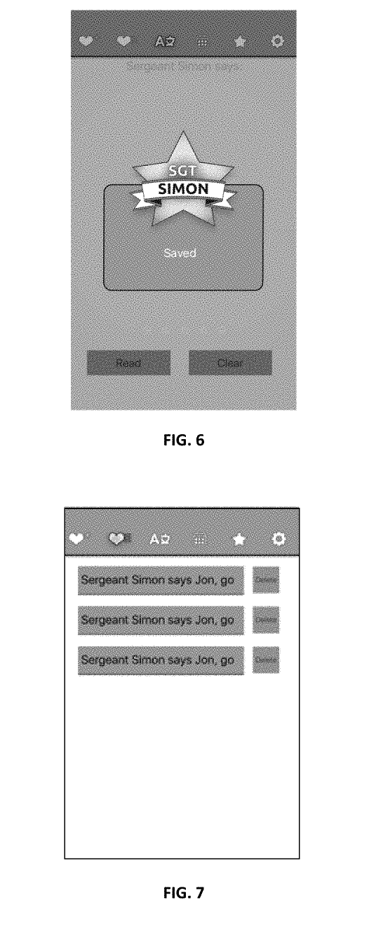

Referring now to FIGS. 5-9, there are shown examples of interface screens for the software application of the external device 400. FIG. 4 shows an exemplary screen for managing statements that can be sent to the toy device 100 to be played on the toy device 100. The screen of FIG. 4 shows that no statements have been saved. FIG. 5 shows a screen for entering a statement using a touch keypad of the external device 400. For example, a statement such as “Sergeant Simon says, remember to brush your teeth” can be entered on the screen of FIG. 5. Generally, any statement or text information can be entered and saved, as shown in FIG. 6. In various embodiments, the “Read” button of FIG. 6 can be used to send the text information to the cloud server 200 to be converted into an audio clip. In various embodiments, the cloud server 200 can automatically convert any text statement saved at the software application into an audio clip, such that the “Read” button can function to transmit the audio clip to the toy device 100 to be played on the speaker 120 of the toy device 100.

In various embodiments, the text and audio information may be locally stored in the device 400 in which the software application 300 is located. In various embodiments, multiple text statements and corresponding audio clips received from the cloud server 200 can be locally saved and managed by the software application, as shown in FIG. 7. The software application can receive a user selection of one of the text statements, access the audio clip corresponding to the selected text statement, and communicate the audio clip to the toy device 100 for output by the speaker 120.

Accordingly, described above are systems and methods for encouraging behavior using an interactive toy device by sending voice statements to the toy device to be played. The following will describe a related reward system.

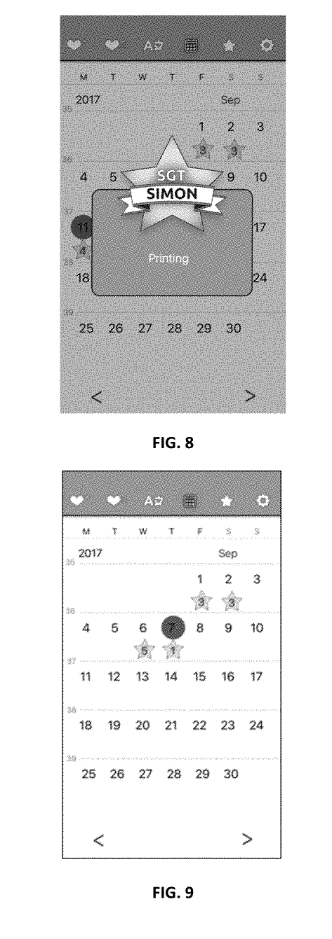

FIG. 8 shows an exemplary screen of the software application for encouraging behavior with rewards. As mentioned in connection with FIGS. 1 and 2, the toy device 100 includes a reward dispenser which can dispense a reward, such as a sticker 140, through an opening in the housing 130 of the toy device 100. In various embodiments, the software application can control the reward dispenser of the toy device 100 via the wireless connection (410, FIG. 3) between the external device 400 and the toy device 100. For example, referring to FIG. 8, the software application screen may include a button that causes the software application to send an instruction to the toy device to dispense a reward, such as a sticker.

Referring to FIG. 9, the software application can track the rewards progress in a calendar or a board or sheet, to track the number of stickers earned. For example, a parent may use her smartphone 400 to direct the toy device 100 to say “Sergeant Simon says, remember to brush your teeth.” When the child successfully brushes her teeth, the parent may trigger the toy device 100 to dispense a sticker 140 by sending a signal to the toy device 100 via the software application. Then, the software application can record in the calendar that a reward was dispensed. Over time, the parent can determine from the progress of rewards how the child's behavior may be improving or not improving.

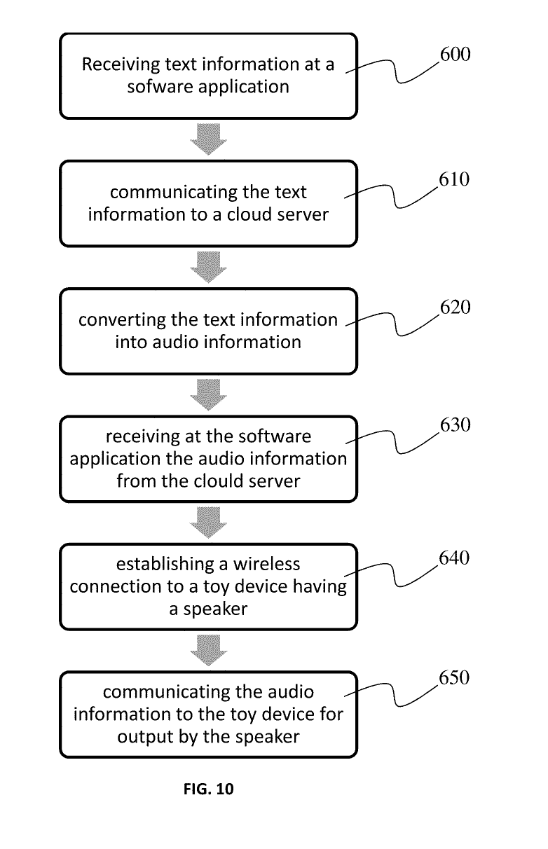

Referring now to FIG. 10, there is shown a flow diagram of an operation for causing the toy device 100 to play audio statements, in accordance with the aspects described above herein. The process includes receiving text information at a software application 600, communicating the text information to a cloud server 610, converting the text information into audio information at the cloud server 620, receiving at the software application the audio information from the cloud server 630, establishing a wireless connection to the toy device 640, and communicating the audio information to the toy device 100 for output by the speaker of the toy device.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The systems described herein may also utilize one or more controllers to receive various information and transform the received information to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for behavior encouragement, comprising:
a software application configured to provide audio information;
a toy device including:
a figurine;
a speaker;
a wireless receiver configured to receive the audio information provided by the software application; and
hardware electronics configured to process the audio information for output to the speaker; and
a cloud server configured to communicate with the software application, the cloud server configured to receive text information from the software application, convert the text information into the audio information, and provide the audio information to the software application.

2. The system of claim 1, wherein the toy device further includes a dispenser configured to dispense a reward.

3. The system of claim 2, wherein the software application is further configured to track the reward on a calendar.

4. The system of claim 2, wherein the toy device includes a housing enclosing the hardware electronics, the dispenser, and the speaker.

5. The system of claim 4, wherein the housing includes an opening operably coupled to the dispenser and sized for the dispenser to dispense the reward through the opening.

6. A method for behavior encouragement, the method comprising:
receiving text information at a software application;
communicating the text information from the software application to a cloud server configured to convert the text information into audio information;
receiving, at the software application, the audio information from the cloud server;
accessing a wireless connection to a toy device having a speaker; and
communicating, over the wireless connection, the audio information to the toy device for output by the speaker.

7. The method of claim 6, further comprising locally storing the text information and the audio information in a device where the software application is located.

8. The method of claim 7, further comprising locally storing a plurality of text information and a plurality of corresponding audio information received from the cloud server, the plurality of text information including the text information and the plurality of corresponding audio information including the audio information.

9. The method of claim 8, further comprising:
receiving, at the software application, a selection of one of the plurality of text information;
accessing, by the software application, one of the plurality of audio information corresponding to the selected text information; and
communicating, over the wireless connection, the one of the plurality of audio information to the toy device for output by the speaker.

10. The method of claim 6, further comprising tracking, by the software application, rewards on a calendar, wherein the toy device further includes a reward dispenser.

11. The method of claim 10, further comprising:
communicating, over the wireless connection, an instruction to the toy device to dispense a reward; and
tracking, at the software application, in the calendar that a reward has been dispensed.
